(19) United States
(12) Patent Application Publication
(10) Pub. No.: US 2024/0104367 A1
(43) Pub. Date: Mar. 28, 2024

(54) MODEL DECORRELATION AND SUBSPACING FOR FEDERATED LEARNING

(71) Applicant: QUALCOMM Incorporated, San Diego, CA (US)

(72) Inventors: Jamie Menjay LIN, San Diego, CA (US); Debasmit DAS, San Diego, CA (US)

(21) Appl. No.: 17/934,098

(22) Filed: Sep. 21, 2022

(51) Int. Cl. G06N 3/08; H04B 17/391

(52) U.S. Cl. CPC G06N 3/08; H04B 17/3913

(57) ABSTRACT

Certain aspects of the present disclosure provide techniques and apparatus for training a machine learning model. An example method generally includes partitioning a machine learning model into a plurality of partitions. A request to update a respective partition of the plurality of partitions in the machine learning model is transmitted to each respective participating device of a plurality of participating devices in a federated learning scheme, and the request may specify that the respective partition is to be updated based on unique data at the respective participating device. Updates to one or more partitions in the machine learning model are received from the plurality of participating devices, and the machine learning model is updated based on the received updates.

### INTRODUCTION

Aspects of the present disclosure relate to federated learning.

Federated learning generally refers to various techniques that allow for training a machine learning model to be distributed across a plurality of client devices, which beneficially allows for a machine learning model to be trained using a wide variety of data. For example, using federated learning to train machine learning models for facial recognition may allow for these machine learning models to train from a wide range of data sets including different sets of facial features, different amounts of contrast between foreground data of interest (e.g., a person's face) and background data, and so on.

In some examples, federated learning may be used to learn embeddings across a plurality of client devices, based on an assumption that data heterogeneity across devices may allow for the training of machine learning models using a wide variety of data. However, training machine learning models using federated learning techniques may not account for various issues with the data used in training the machine learning model. For example, while data on different participating devices used to train a machine learning model using federated learning may allow for a machine learning model to be trained using a wide variety of data, various shifts or biases may exist that may adversely affect the training of the machine learning model (e.g., cause a model to be biased, result in a model that is underfit or overfit, etc.). In another example, sharing weights associated with output layers of a model in a federated learning paradigm may result in the exposure of sensitive data or allow for the reconstruction of sensitive data from data exposed by an output layer of a model.

Accordingly, what is needed are improved techniques for training machine learning models using federated learning techniques.

### BRIEF SUMMARY

Certain aspects provide a method for training a machine learning model. The method generally includes partitioning a machine learning model into a plurality of partitions. A request to update a respective partition of the plurality of partitions in the machine learning model is transmitted to each respective participating device of a plurality of participating devices in a federated learning scheme, and the request may specify that the respective partition is to be updated based on unique data at the respective participating device. Updates to one or more partitions in the machine learning model are received from the plurality of participating devices, and the machine learning model is updated based on the received updates.

Other aspects provide a method for training a machine learning model. The method generally includes receiving, from a server, information defining an orthogonal partition in a machine learning model to be updated and constraints for updating the orthogonal partition. The orthogonal partition generally includes a partition for a first participating device in a federated learning scheme that is decorrelated from a partition for a second participating device in the federated learning scheme. The orthogonal partition in the machine learning model is updated based on local data. Information defining the updated orthogonal partition in the machine learning model is transmitted to the server.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example environment in which machine learning models are trained by a plurality of client devices using federated learning techniques.

FIG. 2 illustrates example operations that may be performed by a server to distribute updating of a machine learning model across a plurality of client devices in a federated learning scheme, according to aspects of the present disclosure.

FIG. 3 illustrates example operations that may be performed by a client device for updating a machine learning model in a federated learning scheme, according to aspects of the present disclosure.

FIG. 4 illustrates an example of messages exchanged between participating devices in a federated learning scheme for training and/or updating a machine learning model, according to aspects of the present disclosure.

FIG. 5 illustrates an example implementation of a processing system in which training of a machine learning model across client devices can be performed, according to aspects of the present disclosure.

FIG. 6 illustrates an example implementation of a processing system in which a machine learning model can be trained, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training a machine learning model using federated learning techniques.

In systems where a machine learning model is trained using federated learning, the machine learning model is generally defined based on model updates (e.g., changes in weights or other model parameters) generated by each of a plurality of participating client devices. Generally, each of these client devices may train a model using data stored locally on the client device. By doing so, the machine learning model may be trained using a wide variety of data and leverage heterogeneity of data across users, which may reduce the likelihood of the resulting global machine learning model underfitting data (e.g., resulting in a model that neither fits the training data nor generalizes to new data) or overfitting the data (e.g., resulting in a model that fits too closely to the training data such that new data is inaccurately generalized).

However, because training machine learning models using federated learning techniques generally involves training a machine learning model on heterogeneous data, various challenges may arise. For example, if a global machine learning model is initially trained using data from a first subset of users and retrained using data from a second subset of users, differences in the data from the first subset of users and the second subset of users may not be fully captured in model updates or may result in a model that is trained with an unbalanced data set that causes the model to be biased towards data from scenarios that are more common across the data from the first subset of users as compared to the second subset of users. Thus, the global performance of the machine learning model may be degraded, as the machine learning model may not retain characteristics of data provided by any particular participant in training the machine learning model using federated learning techniques.

In another example, a client that has data in a first class of data can re-train the global machine learning model, which may entail updating a variety of weights. The updated weights may include both weights associated with the first class of data and weights associated with an unrelated second class of data. When the global model is updated based on these weights, the updated weights associated with the second class of data may “tamper” with, or otherwise modify, existing weights that are known to produce acceptable performance with respect to the second set of data. Thus, while performance of the machine learning model may improve with respect to the first set of data, global retraining by client devices in a federated learning scheme may inadvertently degrade the performance of the machine learning model with respect to the second set of data and may not allow for successful continual learning for the machine learning model.

Aspects of the present disclosure provide techniques for federated learning of machine learning models that uses model decorrelation and subspacing to localize training and updating (or retraining) of machine learning models to different spaces that may correspond to unique data associated with each device that participates in a federated learning scheme to train or update a machine learning model. Generally, model decorrelation and subspacing may refer to the use of various techniques to decompose a machine learning model into a plurality of portions which may have minimal similarities to each other such that each of these portions can be independently trained and updated. A client device may be configured to train or update a portion of a machine learning model based on information about the client device and contribute the retrained portion of the machine learning model to a server coordinating training of the machine learning model across a plurality of participating devices. Because each client device may be configured to train or update only a portion of the machine learning model, aspects of the present disclosure may reduce the complexity of training operations on a client device and may reduce the amount of resources needed to communicate updates to the machine learning model to a server that coordinates the federated learning scheme, as the client device may communicate updated weights for only a portion of the machine learning model instead of updated weights for the entirety of the machine learning model. Further, using model decorrelation and subspacing in federated learning schemes may result in improved accuracy in machine learning models trained using federated learning techniques and may allow for continual learning in machine learning models that preserves the outcomes of previous learning operations on each specific portion of the machine learning model.

### Example Federated Learning Architecture for Updating Partitions in Machine Learning Models

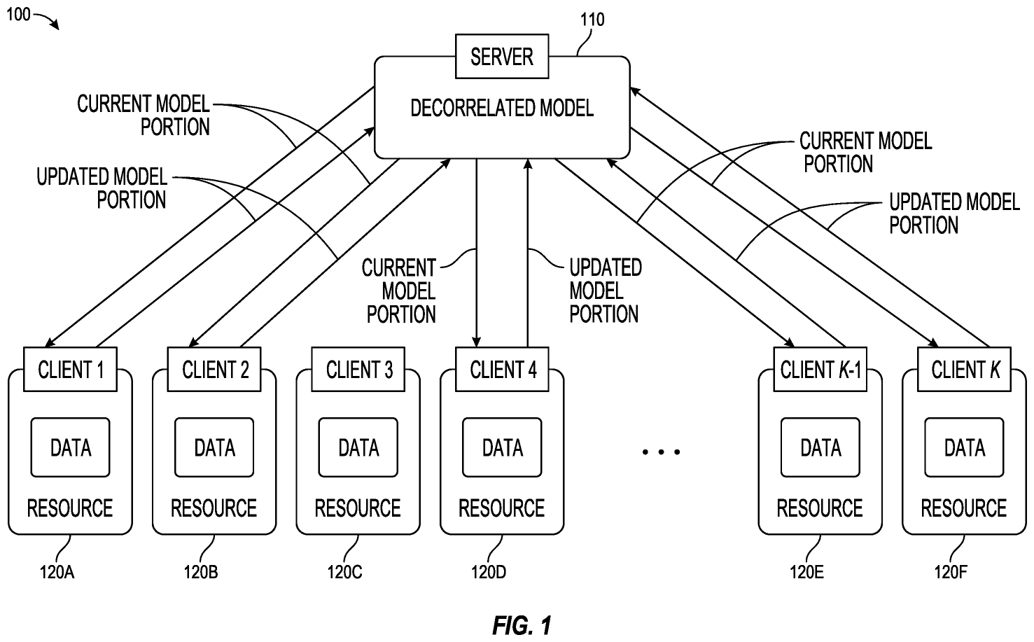

FIG. 1 depicts an example environment 100 in which machine learning models are trained by a plurality of client devices using federated learning techniques. As illustrated, environment 100 includes a server 110 (e.g., a federated learning server) and a plurality of client devices 120A-120F (e.g., federated learning clients).

Server 110 generally maintains a machine learning model that may be updated by one or more client devices 120. The global machine learning model may be an embedding network defined according to the equation g_{θ}(Ψ):χ→ [symbol] with input data x∈χ. The embedding network generally takes x as an input and predicts an embedding vector g_{θ}(x) In some examples, the embedding network may be learned based on classification losses or metric learning losses. Classification losses may include, for example, softmax-based cross entropy loss or margin-based losses, among other types of classification losses. Metric learning losses may include, for example, contrastive loss, triplet loss, prototypical loss, or other metric-based losses.

As discussed, updating a global model using federated learning techniques may result in various inaccuracies in the resulting updated model, and because updating the entirety of a model may be computationally expensive and impose a significant communications overhead in transmitting information about an entirety of a machine learning model between a server 110 and the one or more client devices 120. To improve the accuracy of a machine learning model trained using federated learning techniques and reduce the messaging overhead involved in updating a machine learning model, a machine learning model may be partitioned into a plurality of decorrelated partitions, and each of these decorrelated partitions can be independently updated by one or more of client devices 120A-120F based on local data stored at these client devices.

To partition a machine learning model into a plurality of decorrelated partitions, a model may be initially trained using data from a plurality of data sources. This trained model may then be partitioned into a plurality of orthogonalized partitions in which the variables specifically relevant to one partition are different from the variables specifically relevant to other partitions from the plurality of orthogonalized partitions. Because each partition is substantially orthogonal to other partitions (as discussed in further detail below), each partition may be independently updated without adversely affecting the performance of other partitions in the machine learning model.

In some aspects, the machine learning model may be partitioned during initial training of the machine learning model. To partition the machine learning model during initial training of the machine learning model, kernels of the machine learning model, which represent portions of a machine learning model that can solve non-linear problems using a linear classifier, may be substantially orthogonalized. For example, a layer in a neural network, corresponding to a kernel K of the machine learning model, may be represented as a matrix. The kernel K may be orthogonalized based on a decorrelation loss, L_{decor}, which may be represented by the equation:

L_{decor}=∥K^{T}K−αI∥^{p},p∈{1,2, . . . }

where K^{T} represents the transpose of the matrix representing kernel K, α represents a scaling factor, I represents the identity matrix of the matrix representing kernel K, and p represents a power in terms of a number of matrix multiplication operations performed on the residual matrix represented by ∥K^{T}K−αI∥. The product of K^{T}K may result in the calculation of an autocorrelation matrix representing the autocorrelation properties of the kernel K. Subtracting I, or a scaled version of I, from the autocorrelation properties of kernel K may allow terms in the autocorrelation matrix K^{T}K other than the terms along the diagonals of the autocorrelation matrix, to remain in quadratic form for use as a loss term in updating the model.

The model may then be trained based on a total loss term, Lₜₒₜₐₗ, that may be represented as the sum of a legacy loss term L_{legacy} and the decorrelation loss term L_{decor}. In some aspects, a weight may be applied to the decorrelation loss term L_{decor} in generating the total loss term Lₜₒₜₐₗ, such that Lₜₒₜₐₗ=L_{legacy}+βL_{decor}. In some aspects, the resulting model may be at least partially orthogonalized (or decorrelated), as the model may be optimized on a loss term that includes a legacy loss term.

In some aspects, a machine learning model may be partitioned into a plurality of orthogonal partitions after the model is initially trained. Various techniques may be used to orthogonalize the machine learning model after initial training, including Gram-Schmidt orthogonalization, singular value decomposition (SVD), Cholesky decomposition, and other decorrelation techniques that may allow for a model to be partitioned into a plurality of orthogonal partitions (e.g., by removing or reducing weight autocorrelations within the machine learning model and/or kernel cross-correlations within the machine learning model).

Gram-Schmidt orthogonalization generally allows for the conversion of a set of vectors representing a machine learning model into a set of orthogonal vectors. Each vector in the set of orthogonal vectors may represent an orthogonal portion of a machine learning model which may be independently updated using federated learning techniques, as discussed herein. Generally, for a set of vectors S with size k, the orthogonal vectors generated using Gram-Schmidt orthogonalization may be a set of vectors spanning the same k-dimensional subspace as the set of vectors S. Each vector may, for example, represent a portion of the machine learning model and may be projected into a space such that any pair of vectors in the orthogonalized set of vectors is orthogonal to each other.

In some aspects, singular value orthogonalization may be used to generate the plurality of orthogonal partitions of the machine learning model. Singular value orthogonalization may allow for the derivation of decorrelated kernels for the model by factorizing the matrix representing the kernel K, having dimensions of m×n, according to the equation K=UΣV*. U generally represents a unitary matrix with dimensions m×m, Σ generally represents a rectangular diagonal matrix, and V generally represents a unitary matrix with dimensions n×n.

In still further aspects, Cholesky decomposition (or whitening) may be used to generate the plurality of orthogonal partitions of the machine learning model. Cholesky decomposition generally allows for a matrix, such as the matrix representing the kernel K, into a product of a plurality of matrices. To generate the plurality of orthogonalized partitions for the machine learning model, a whitening matrix W may be generated based on a matrix C and its transform C^{T}.

The substantially orthogonal partitions into which the machine learning model may be divided may include, in some aspects, a common subnetwork and a plurality of non-common subnetworks. The common subnetwork may be a network that can be updated by any participating client device 120 and may include one or more initial portions of the machine learning model. For example, the common subnetwork may include the one or more layers that are used to extract features from an input prior to taking any action on the extracted features. The plurality of non-common subnetworks may be “scenario-dependent” subnetworks that are suited for performing machine learning operations on specific data sets. For example, in a situation in which the machine learning model is used in a wireless communications network (e.g., predicting channel state information (CSI), generating embedded messaging based on various channel state information measurements, etc.), different scenarios may correspond to different sets of channel conditions, different types of devices, and the like. One partition in the machine learning model may correspond, for example, to situations in which a device has strong signal strength, another partition in the machine learning model may correspond to situations in which a device has weak signal strength, and so on. It should be recognized that this is but one example of scenarios that may correspond to different partitions within a machine learning model, and other scenarios may exist based on the purpose for which the machine learning model is trained and deployed.

After partitioning the machine learning model, the model may be subspaced using various techniques such that the weights of the machine learning model are divided into unique spaces that can be independently updated. As an illustrative example, a matrix of weights W for the machine learning model in which two scenarios exist may be defined as:

$$W = [ \begin{matrix}{W}_{0} \\ {W}_{1} \\ {W}_{2}\end{matrix} ] ,$$

where W₀ represents a set of weights that are common for both a first scenario and a second scenario, W₁ represents a set of weights unique to the first scenario, W₂ represents a set of weights unique to the second scenario, and W₁ and W₂ are decorrelated (e.g., as discussed above). To partition the model into the plurality of orthogonalized partitions, feature projection techniques can be used so that features in a forward training pass at certain locations in the machine learning model are used to project a set of features, and the projected set of features are passed to an activation function to select a subspace of the kernels or channels in the machine learning model for processing.

In another example, gradient projection can be used to subspace the machine learning model. Generally, gradient projection allows for gradients backpropagated at certain locations in the machine learning model can be used to project other gradients. A subset of the project gradients may be updated and used for subsequent processing. For example, partitions of the machine learning model may be grouped into a null space and a non-null space. Gradients may be updated for partitions of the machine learning model in the non-null space; however, gradients may not be updated for partitions of the machine learning model in the null space.

For example, assume that a loss function for a machine learning model is represented according to the equation:

$$L = \frac{1}{2} {‖ Wx - y ‖}_{2}^{2} ,$$

where W represents a set of weights for the neural network, x represents a set of input features, and y represents an activation generated from the set of input features x. The gradient with respect to the weights W may be represented by the equation:

∇_{W}L=(Wx−y)x^{T}=δx^{T},

where δ∈ [symbol] and x^{T} represents a transpose of the input features x. Thus, the gradient update may lie in the linear span of x. Based on the orthogonal portions of the machine learning model, with gradient projection, a subset of the weights W may need to be updated rather than the entirety of W. That is, using gradient projection, weights Wᵢ⊂

$$W = [ \begin{matrix}{W}_{0} \\ {W}_{1} \\ {W}_{2}\end{matrix} ]$$

may be updated.

For example, assume that a device includes data that is suitable for updating the partition of the machine learning model associated with the first scenario in the two-scenario example discussed above. These partitions may, in some aspects, be kernels of a machine learning model which allow low-dimensional data to be used in high-dimensional spaces, and each kernel may be a portion of weights in a same layer or kernel of the neural network. Because W₀ represents a set of weights that are shared across all scenarios (e.g., weights associated with a common partition in the model) and W₁ represents a set of weights that are applicable to the first scenario (e.g., weights associated with a partition for the first scenario in the model), the device may update the common partition and the partition for the first scenario in the model, but may not update the partition for the second scenario in the model. Thus, by partitioning the machine learning model into the plurality of orthogonalized partitions, only portions of the machine learning model that are relevant to a particular scenario may be updated by a device participating in a federated learning scheme, and negative effects from updating a global model with respect to other, unrelated, scenarios (e.g., tampering with weights unrelated to the particular scenario, weight forgetting, or other data contamination) may be avoided. The resulting machine learning model may thus be updated to improve the performance of the model with respect to the particular scenario while leaving the performance of the model with respect to the particular scenario substantially unchanged.

In some aspects, constraints for updating a partition may be determined based on information reported by the client devices 120 that are participants in the federated learning scheme. For example, for defining constraints for updating partitions for a machine learning model used in a wireless communications system, each client device 120 (which may be, for example, a user equipment (UE) in a wireless communication system, such as a mobile phone, a tablet computer, an autonomous vehicle UE, etc.) may report various radio measurements to the server 110 (which may be, for example, a network entity, such as a base station, that serves one or more UEs). The constraints may be based on the reported radio measurements from each client device 120 and may, for example, indicate whether constraints are defined for any particular user and, if so, which weights are and are not to be updated by each participating client device 120 in the federated learning scheme.

To update the machine learning model, server 110 can select a plurality of client devices 120 that are to participate in a federated learning scheme to update the machine learning model. The plurality of client devices 120 may include an arbitrary number m of client devices and may be selected based on various characteristics, such as the data available at each client device, the partitions in the machine learning model to be updated (e.g., due to poor inference performance), and the like. For example, as illustrated, server 110 can select client devices 120A, 120B, 120D, 120E, and 120F as the participating devices in the federated learning scheme for updating the machine learning model. These devices, for example, may have reported the presence of data that the server 110 deems is needed to update selected partitions of the machine learning model. Client device 120C, however, is not selected as a participating device in the federated learning scheme, as this device may not have data that would be needed to update the selected partitions of the machine learning model (but instead may have indicated, at least implicitly, to the server 110 that client device 120C has data that may be relevant for updating a partition of the machine learning model corresponding to a scenario for which inference performance is considered acceptable). In some aspects, other considerations may also be used to select the client devices 120 that will participate in the federated learning scheme to update the machine learning model. These other considerations may include, for example, how recently a client device has participated in training (or updating) the global machine learning model, mobility and power characteristics, available computing resources that can be dedicated to training or updating a model, and the like.

After server 110 selects the participating client devices 120A, 120B, 120D, 120E, and 120F, server 110 can invoke a model updating process at each of client devices 120A, 120B, 120D, 120E, and 120F by providing the current version of a partition in the machine learning model to the client devices 120A, 120B, 120D, 120E, and 120F. The client devices 120A, 120B, 120D, 120E, and 120F may generate an updated model partition based on the data stored at each client device and upload the updated model partition to server 110 for integration into the global machine learning model.

Server 110 can update the machine learning model using various model aggregation techniques. For example, as illustrated in FIG. 1, the server 110 can update partitions of the machine learning model based on a running average of the weights associated with updated model partitions generated by the client devices 120 over time or based on other statistical measures of the weights associated with the updated model partitions generated by the client devices 120 over time. In some aspects, newer model information (e.g., weights, parameter values, etc.) may replace older model information in a data set of models over which the machine learning model is generated. As discussed, in updating the machine learning model, the machine learning model may be updated on a per-partition basis, and updating one partition in the machine learning model may not affect or may have a limited effect on the parameters (e.g., weights) associated with a different orthogonal partition within the machine learning model. After the machine learning model is updated, server 110 can deploy the updated machine learning model to the client devices 120A-120F in environment 100 for use in performing inferences at each of the client devices 120A-120F.

### Example Methods for Updating Partitions in Machine Learning Models

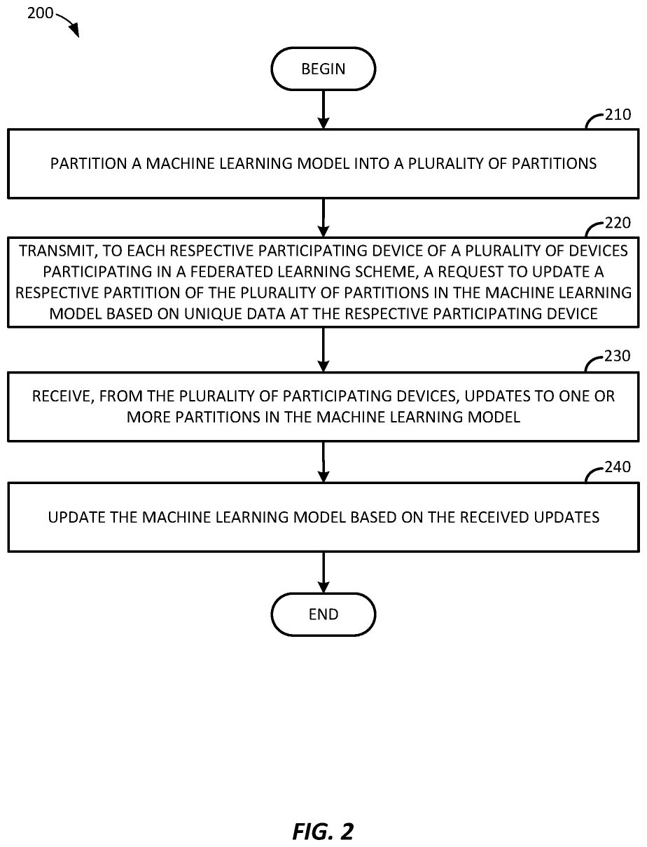

FIG. 2 illustrates example operations 200 that may be performed (e.g., by a server, a network entity in a wireless communication network, etc., such as server 110 illustrated in FIG. 1) to distribute updating of a machine learning model across a plurality of client devices in a federated learning scheme, according to aspects of the present disclosure.

As illustrated, operations 200 begin at block 210, with partitioning a machine learning model into a plurality of partitions. Generally, in partitioning the machine learning model into a plurality of partitions, each partition may be made substantially orthogonal to the other partitions in the machine learning model. As discussed above, in partitioning the machine learning model into the plurality of partitions, the partitions may be made at least partially orthogonal (e.g., when such orthogonalization is based on a legacy loss and a decorrelation loss) or fully orthogonal (e.g., when such orthogonalization is performed after initial training of the machine learning model); while the partitions in the machine learning model need not be completely orthogonal, the partitions may generally have a high degree of orthogonality. Each partition may correspond to one of a plurality of scenarios for which the machine learning model is trained to perform various inference operations. In some aspects, the partitions may be generated as orthogonal portions of a same kernel such that the kernel includes a subset of weights associated with a common portion of the machine learning model and a plurality of subsets of weights associated with different scenarios for which the machine learning model is trained. In some aspects, the partitions may be different kernels, with a first kernel corresponding to a common portion of the machine learning model and a plurality of other kernels corresponding to scenario-specific portions of the machine learning model.

In some aspects, the machine learning model may be partitioned into the plurality of partitions during initial training of the machine learning model. To partition the machine learning model into the plurality of partitions during initial training of the machine learning model, the machine learning model may be orthogonalized on a per-kernel basis. In orthogonalizing the machine learning model, a total loss may be defined in terms of a legacy loss term and a decorrelation loss term. The decorrelation loss term may be represented by the difference between the product between a matrix K representing a kernel and the transpose K^{T}, less an identity matrix I of matrix K. The decorrelation loss term may thus include terms in the autocorrelation matrix K^{T}K other than the terms along the diagonals of the autocorrelation matrix in quadratic form.

In some aspects, the machine learning model may be partitioned into the plurality of partitions after the machine learning model is initially trained. Various techniques can be used to partition the machine learning model after initial training of the machine learning model. For example, the machine learning model can be partitioned into the plurality of partitions based on Gram-Schmidt orthogonalization, singular value decomposition, Cholesky decomposition, or other decorrelation techniques that remove or reduce autocorrelation between weights in the machine learning model and/or cross-correlation in the kernels of the machine learning model.

In some aspects, the partitions in the machine learning model may be generated based on feature projection techniques. In using feature projection techniques, features at certain locations in the machine learning model during a forward pass (e.g., during a calculation process in which an input traverses from an initial portion to a later portion of the machine learning model) may be used to project the features of an input into the machine learning model. These projected features may be passed to an activation function to select partitions of the machine learning model to be used for processing. In a feature projection technique, each partition of the plurality of partitions may be associated with a set of weights. A first partition of the plurality of partitions may be a common partition having a common set of weights applicable to any scenario for which the machine learning model is trained, and a plurality of second partitions of the plurality of partitions may be partitions having weights associated with one of a plurality of defined scenarios for which the machine learning model is trained. As discussed, by partitioning the machine learning model into a common partition and a plurality of scenario-specific partitions, the common partition and one of the plurality of scenario-specific partitions may be updated by a client device participating in a federated learning scheme to update the machine learning model, which may allow for specific portions of the machine learning model to be updated while leaving other portions of the machine learning model unchanged.

In some aspects, the partitions in the machine learning model may be selected based on gradient projection techniques. In using gradient projection techniques, gradients identified in some locations in the machine learning model may be used to project gradients for other locations in the machine learning model. A subspace of the projected gradients may be updated, while other projected gradients may remain unchanged. In this example, the plurality of partitions into which the machine learning model is partitioned may be organized into a null space and a non-null space. The null space may correspond to portions of the machine learning model that are to remain unchanged, while the non-null space may correspond to portions of the machine learning model that are to be updated. In doing so, a subset of the weights, corresponding to portions of the machine learning model associated with specific scenario(s), may be updated, and other portions of the machine learning model may remain unchanged.

At block 220, operations 200 proceed with transmitting, to each respective participating device of a plurality of participating devices in a federated learning scheme, a request to update a respective partition of the plurality of partitions in the machine learning model. Generally, the request may indicate that the plurality of partitions may be updated based on unique data at each respective participating device in the federated learning scheme. As discussed herein, the plurality of participating devices in the federated learning scheme may include a subset of client devices connected with the server which have relevant data for updating different orthogonalized portions of the machine learning model, but need not include devices that do not have relevant data for updating orthogonalized portions of the machine learning model but may have previously participated in updating the machine learning model.

In some aspects, the participating devices in the federated learning scheme may send various reports to a server coordinating the updating of a machine learning model using a federated learning scheme. These reports may include, for example, information identifying (at least in general terms) the type of data available at each client device for use in updating the machine learning model, and, in some aspects, other information that can be used in selecting client devices to participate in a federated learning scheme. The type of data may be signaled in such a way that may minimize the risk of compromising the privacy or security of the local data at each client device. For example, a client device can share, in general terms, information about the types of data stored on the client device, which may indicate the scenario(s) for which the client device can update the machine learning model. In one example, where the machine learning model is used to predict parameters for wireless communications between a network entity (or one or more components of disaggregated network entity) and a user equipment (UE), the data at each client device may include radio measurements at each respective device. The measurements may, for example, correspond to a general classification of radio conditions at each UE, and the classification of these radio conditions may be used to select the portion(s) of the machine learning model to be updated by each respective device.

At block 230, operations 200 proceed with receiving, from the plurality of participating devices, updates to one or more partitions in the machine learning model. In some aspects, the updates received from each device of the plurality of participating devices may include weight data and/or other information associated with at least a specific partition of the machine learning model for which a specific device of the plurality of participating devices was responsible for updating. In some aspects, the updates received from each device may also include weights for a common partition of the machine learning model that are shared across different partitions of the machine learning model (and thus, common to each of a plurality of scenarios for which the machine learning model is trained to generate inferences).

At block 240, operations 200 proceed with updating the machine learning model based on the received updates. In some aspects, to update the machine learning model, the updates may be combined with the existing data in the machine learning model. For example, where the updates include weight data, the weight data may be combined by averaging the existing weight data and the updated weight data for each partition in the machine learning model. In some aspects, the weight updates from each participating device of the plurality of participating devices may be aggregated into an overall update to be applied to the machine learning model. Generally, updating the machine learning model may involve updating the partitions of a machine learning model that the participating devices were requested to update, while leaving the partitions that client devices were not requested to update in their pre-update states.

In some aspects, various constraints may be identified for updating partitions in the machine learning model. These constraints may be identified based on reporting received from each participating device of the plurality of participating devices and may be signaled to each participating device of the plurality of participating devices. For example, these constraints, if established, may indicate which parameters within a partition of the machine learning model are to be updated and which parameters within the partition of the machine learning model are to remain unchanged during the update process.

Generally, the server can maintain mappings between different portions of a machine learning model and the client device(s) responsible for updating those portions of the machine learning model. Assignments of which portions of a machine learning model are to be managed and updated by a client device may be communicated to the relevant client devices via one or more messages to the relevant client devices (e.g., in messages instructing the participating devices to update portions of the machine learning model, as discussed above with respect to block 220). The server can assign portions of a machine learning model to a specific client device or to multiple client devices and update the machine learning model based on the responses received from the participating client devices, as discussed above.

Note that FIG. 2 is just one example of a method, and other methods including fewer, additional, or alternative steps are possible consistent with this disclosure.

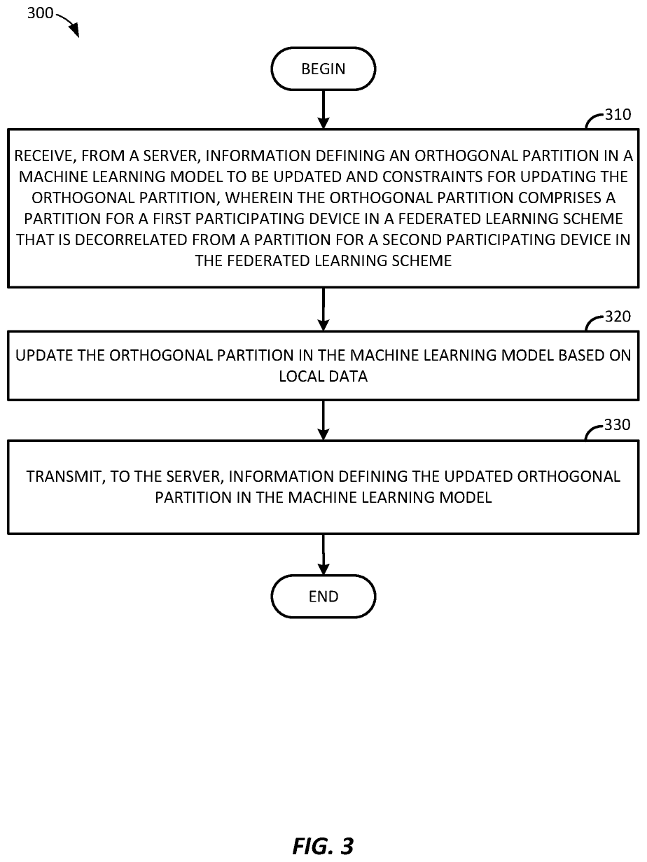

FIG. 3 illustrates example operations 300 that may be performed by a client device (e.g., client device 120 illustrated in FIG. 1) for updating a machine learning model in a federated learning scheme, according to aspects of the present disclosure. The client device may include, for example, a user equipment (UE) in a wireless communications network or other devices which may interact with a server to participate in a federated learning scheme to update a machine learning model.

As illustrated, operations 300 begin at block 310, with receiving information defining an orthogonal partition in a machine learning model to be updated. In some aspects, constraints for updating the orthogonal partition may also be received. The orthogonal partition may, in some aspects, be a partition for a first participating device in a federated learning scheme that is decorrelated from a partition for a second participating device in the federated learning scheme.

At block 320, operations 300 proceed with updating the orthogonalized partition in the machine learning model based on local data.

In some aspects, updating the orthogonal partition in the machine learning model may include updating the orthogonal partition based on a feature projection technique and the local data. In such a case, features at certain locations in the machine learning model during a forward pass may be used to project the features of an input into the machine learning model. These projected features may be passed to an activation function to select partitions of the machine learning model to be used for processing. In a feature projection technique, each partition of the plurality of partitions may be associated with a set of weights. A first partition of the plurality of partitions may be a common partition having a common set of weights applicable to any scenario for which the machine learning model is trained, and a plurality of second partitions of the plurality of partitions may be partitions having weights associated with one of a plurality of defined scenarios for which the machine learning model is trained.

In some aspects, updating the orthogonal partition in the machine learning model may include updating the orthogonal partition based on a gradient projection technique and the local data. In such a case, gradients identified in some locations in the machine learning model may be used to project gradients for other locations in the machine learning model. A subspace of the projected gradients may be updated, while other projected gradients may remain unchanged. In this example, the plurality of partitions into which the machine learning model is partitioned may be organized into a null space and a non-null space. The null space may correspond to portions of the machine learning model that are to remain unchanged, while the non-null space may correspond to portions of the machine learning model that are to be updated.

At block 330, operations 300 proceed with transmitting, to the server, information defining the updated orthogonal partition in the machine learning model. Because the information defining the updated orthogonal partition in the machine learning model may include a set of weights for the orthogonal partition (and, in some cases, a common partition of the machine learning model), but may not include a set of weights for other partitions in the machine learning model, the amount of communications overhead involved in communicating the updated orthogonal partition to the server may be a portion of the communications overhead that would be involved if updated information for the entire machine learning model were transmitted to the server.

In some aspects, operations 300 further include transmitting, to the server, one or more reports. Constraints for updating the orthogonal partition in the machine learning model are based on the one or more reports. The one or more reports may include generalized information about the local data, which may include information identifying (at least in general terms) the type of data available at each client device for use in updating the machine learning model. These reports may, in some aspects, include information that can be used in selecting client devices to participate in a federated learning scheme. In one example, where the machine learning model is used to predict parameters for wireless communications between a network entity (or one or more components of disaggregated network entity) and a user equipment (UE), reports may include radio measurements corresponding to a general classification of radio conditions at each UE.

Note that FIG. 3 is just one example of a method, and other methods including fewer, additional, or alternative steps are possible consistent with this disclosure.

### Example Message Flow Diagram for Updating Partitions in Machine Learning Models

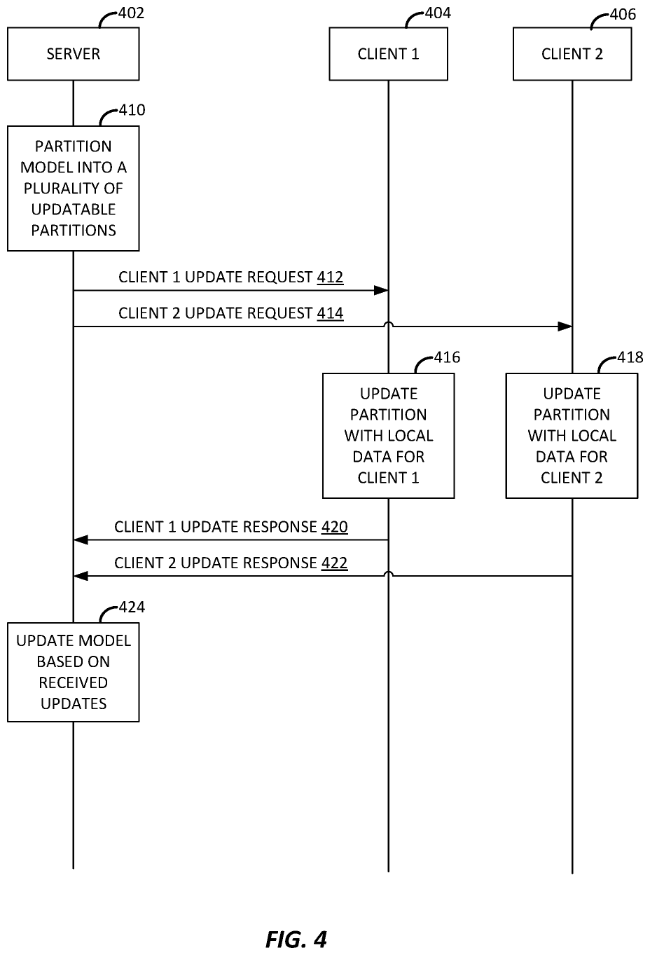

FIG. 4 illustrates an example 400 of messages exchanged between participating devices in a federated learning scheme for training and/or updating a machine learning model, according to aspects of the present disclosure.

As illustrated, example 400 includes messages exchanged between a server 402, a first client 404, and a second client 406. In an aspect where the machine learning model being updated is a model used to predict parameters for communications in a wireless communications system, the server 402 may correspond to a network entity (e.g., a base station), while the first client 404 and the second client 406 may correspond to different user equipments in the wireless communications system served by the base station.

Initially, at block 410, the server 402 partitions a machine learning model into a plurality of updatable orthogonalized partitions. The partitioning of the machine learning model into the plurality of updatable orthogonalized partitions may be performed as part of an initial training process for the machine learning model or may be performed after the machine learning model is trained. If the partitioning is performed as part of the initial training process for the machine learning model, each partition may be at least partially orthogonalized, or partially decorrelated, to other partitions in the machine learning model, as a total loss minimized during training of the machine learning model may include a legacy loss term and a decorrelation loss term. If the partitioning is performed after the machine learning model is initially trained, the partitions in the machine learning model may be substantially or completely orthogonalized from other partitions in the machine learning model.

To update the machine learning model, update requests 412 and 414 are transmitted to first client 404 and second client 406, respectively. Generally the update requests 412 and 414 may specify, to the respective client devices, the partition(s) of the machine learning model that are to be updated using local data at each of these client devices. In some aspects, the update requests 412 and 414 may also specify various constraints which the clients 404 and 406 are to observe while updating the specified partition(s) of the machine learning model. These constraints may indicate, for example, which parameters in a specific partition are to be updated and which parameters in that specific partition are to remain unchanged during the update process.

At block 416, first client 404 updates a partition with local data associated with the first client in response to receiving update request 412. Likewise, at block 418, second client 406 updates a partition with local data associated with the second client in response to receiving update request 414. Updates to the model by first client 404 at block 416 and by second client 406 at block 418 may be independent and may be performed substantially in parallel; however, it should be noted that these operations may complete at different times (e.g., due to differing processing capabilities of each client device, an amount of data used in updating the partition, etc.) and need not be synchronized with each other. After updating the partitions with local data, first client 404 and second client 406 may transmit respective update responses 420 and 422 to server 402.

At block 424, the server updates the machine learning model based on the update responses 420 and 422 received from first client 404 and second client 406. The updates may include, for example, updated weight data for different partitions in the machine learning model. The different partitions may include a common partition with weights applicable across different scenarios for which the machine learning model is trained to perform inference operations and a plurality of partitions that are scenario-specific. As discussed, in updating the machine learning model, the updates may be combined with the existing data in the machine learning model to result in an updated model. These updates may affect only partitions in the machine learning model that the clients 404 and 406 were requested to update, and the partitions in the machine learning model that clients 404 and 406 were not requested to update may remain unchanged.

### Example Processing Systems for Updating Partitions in Machine Learning Models

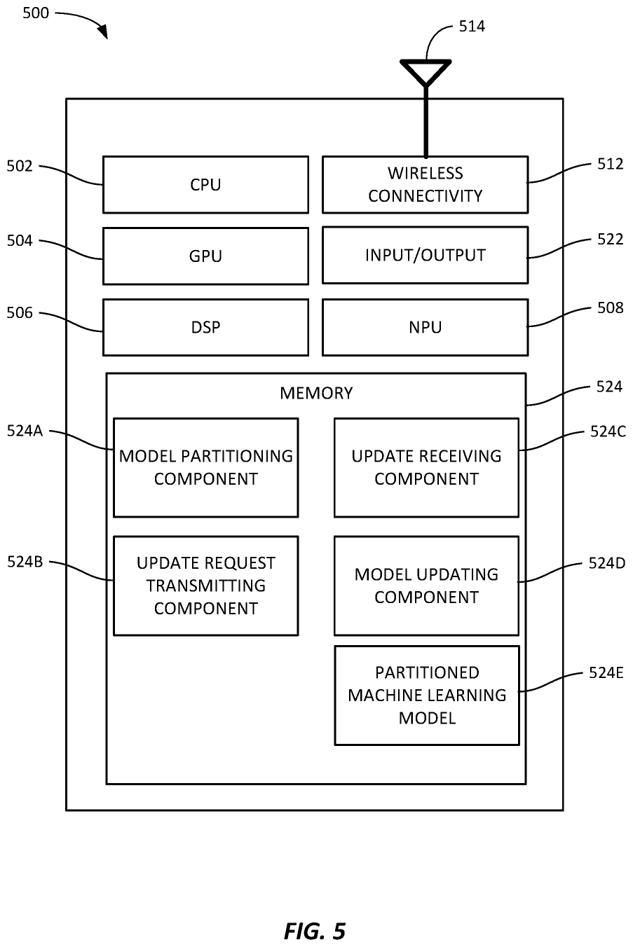

FIG. 5 depicts an example processing system 500 for updating a machine learning model across client devices in a federated learning scheme, such as described herein for example with respect to FIG. 2.

Processing system 500 includes a central processing unit (CPU) 502, which in some examples may be a multi-core CPU. Instructions executed at the CPU 502 may be loaded, for example, from a program memory associated with the CPU 502 or may be loaded from a memory partition (e.g., in memory 524).

Processing system 500 also includes additional processing components tailored to specific functions, such as a graphics processing unit (GPU) 504, a digital signal processor (DSP) 506, a neural processing unit (NPU) 508, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 508 is a part of one or more of CPU 502, GPU 504, and/or DSP 506.

In some examples, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 512 is further connected to one or more antennas 514.

Processing system 500 may also include one or more input and/or output devices 522, such as screens, touch-sensitive surfaces (including touch-sensitive displays), physical buttons, speakers, microphones, and the like.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500.

In particular, in this example, memory 524 includes model partitioning component 524A, update request transmitting component 524B, update receiving component 524C, model updating component 524D, and partitioned machine learning model 524E. The depicted components, and others not depicted, may be configured to perform various aspects of the methods described herein.

Generally, processing system 500 and/or components thereof may be configured to perform the methods described herein.

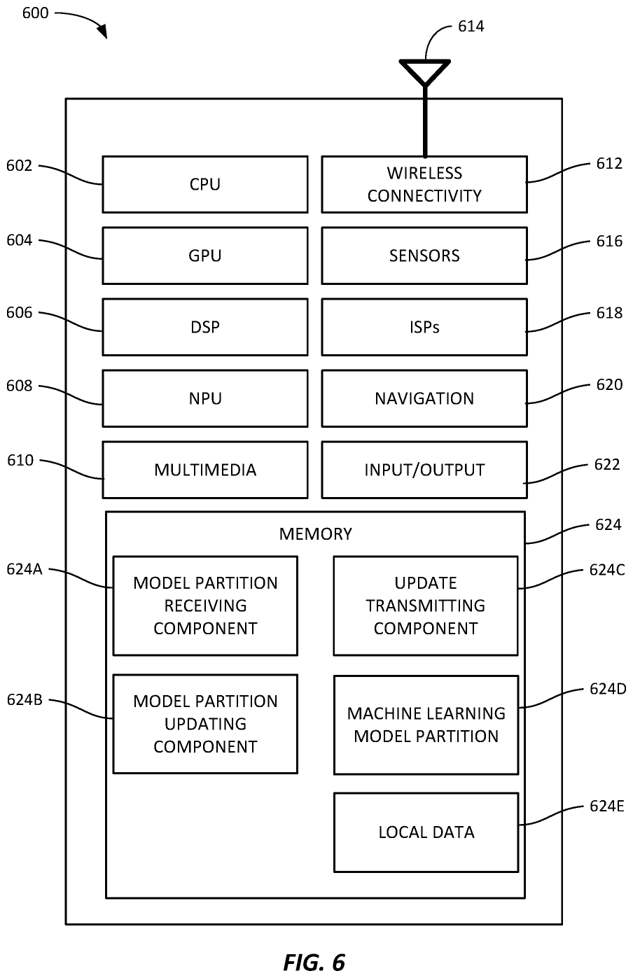

FIG. 6 depicts an example processing system 600 for updating a machine learning model, such as described herein for example with respect to FIG. 3.

Processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., in memory 624).

Processing system 600 also includes additional processing components tailored to specific functions, such as a graphics processing unit (GPU) 604, a digital signal processor (DSP) 606, a neural processing unit (NPU) 608, a multimedia processing unit 610, a wireless connectivity component 612.

An NPU, such as NPU 608, may be as described above with respect to FIG. 6. In one implementation, NPU 608 is a part of one or more of CPU 602, GPU 604, and/or DSP 606.

In some examples, wireless connectivity component 612 may be as described above with respect to FIG. 6.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes model partition receiving component 624A, model partition updating component 624B, update transmitting component 624C, machine learning model partition 624D, and local data 624E. The depicted components, and others not depicted, may be configured to perform various aspects of the methods described herein.

Generally, processing system 600 and/or components thereof may be configured to perform the methods described herein.

Notably, in other embodiments, aspects of processing system 600 may be omitted, such as where processing system 600 is a server computer or the like. For example, multimedia processing unit 610, wireless connectivity component 612, sensor processing units 616, ISPs 618, and/or navigation processor 620 may be omitted in other embodiments.

### Example Clauses

Implementation details are described in the following numbered clauses:

Clause 1: A computer-implemented method, comprising: partitioning a machine learning model into a plurality of partitions; transmitting, to each respective participating device of a plurality of participating devices in a federated learning scheme, a request to update a respective partition of the plurality of partitions in the machine learning model based on unique data at the respective participating device; receiving, from the plurality of participating devices, updates to one or more partitions in the machine learning model; and updating the machine learning model based on the received updates.

Clause 2: The method of Clause 1, wherein partitioning the machine learning model into the plurality of partitions comprises partitioning the machine learning model into a common subnetwork and one or more non-common subnetworks.

Clause 3: The method of Clause 1 or 2, wherein partitioning the machine learning model into the plurality of partitions comprises orthogonalizing the partitions.

Clause 4: The method of Clause 3, wherein orthogonalizing the partitions comprises generating the plurality of partitions based on Gram-Schmidt orthogonalization.

Clause 5: The method of Clause 3 or 4, wherein orthogonalizing the partitions comprises generating the plurality of partitions based on singular value decomposition.

Clause 6: The method of any of Clauses 3 through 5, wherein orthogonalizing the partitions comprises generating the plurality of partitions based on Cholesky decomposition.

Clause 7: The method of any of Clauses 1 through 6, wherein partitioning the machine learning model comprises generating the plurality of partitions in the machine learning model based on a feature projection technique.

Clause 8: The method of Clause 7, wherein: each partition of the plurality of partitions is associated with a set of weights; a first partition of the plurality of partitions comprises a common partition having a common set of weights; and a plurality of second partitions of the plurality of partitions comprise partitions having weights associated with one of a plurality of defined scenarios for which the machine learning model is trained.

Clause 9: The method of any of Clauses 1 through 8, wherein partitioning the machine learning model comprises generating the plurality of partitions in the machine learning model based on a gradient projection technique.

Clause 10: The method of Clause 9, wherein: the plurality of partitions comprises a null space and a non-null space, and the requests to update the one or more partitions in the plurality of partitions comprises requests to update subspaces in the non-null space.

Clause 11: The method of any of Clauses 1 through 10, further comprising: receiving reports from each participating device of the plurality of participating devices; and configuring, for each respective participating device of the plurality of participating devices, constraints for updating a partition in the machine learning model based on the received reports for the respective participating device.

Clause 12: The method of Clause 11, wherein: the one or more participating devices comprise one or more user equipments (UEs) in a wireless communication system, the machine learning model comprises a model for predicting parameters for wireless communications between a network entity and a user equipment (UE), and the data at each respective device comprises one or more radio measurements at each respective device.

Clause 13: The method of any of Clauses 1 through 12, wherein updating the machine learning model based on the received updates comprises aggregating weight updates from each participating device of the plurality of participating devices.

Clause 14: The method of any of Clauses 1 through 13, wherein the method is performed by a network entity in a wireless communication system and wherein the plurality of participating devices comprises user equipments (UEs) served by the network entity.

Clause 15: A computer-implemented method, comprising: receiving, from a server, information defining an orthogonal partition in a machine learning model to be updated and constraints for updating the orthogonal partition, wherein the orthogonal partition comprises a partition for a first participating device in a federated learning scheme that is decorrelated from a partition for a second participating device in the federated learning scheme; updating the orthogonal partition in the machine learning model based on local data; and transmitting, to the server, information defining the updated orthogonal partition in the machine learning model.

Clause 16: The method of Clause 15, further comprising transmitting, to the server, one or more reports, wherein the constraints for updating the orthogonal partition are based on the one or more reports.

Clause 17: The method of Clause 16, wherein the one or more reports include generalized information about the local data.

Clause 18: The method of Clause 16 or 17, wherein the one or more reports comprise radio measurements corresponding to a general classification of radio conditions at a device.

Clause 19: The method of any of Clauses 15 through 18, wherein updating the orthogonal partition in the machine learning model comprises updating the orthogonal partition based on a feature projection technique and the local data.

Clause 20: The method of any of Clauses 15 through 19, wherein updating the orthogonal partition in the machine learning model comprises updating the orthogonal partition based on a gradient projection technique and the local data.

Clause 21: The method of any of Clauses 15 through 20, wherein the method is performed by a user equipment (UE) in a wireless communication system and wherein the server is associated with a network entity serving the UE in the wireless communication system.

Clause 22: An apparatus comprising: a memory having executable instructions stored thereon; and a processor configured to execute the executable instructions to cause the apparatus to perform a method in accordance with of any of Clauses 1 through 21.

Clause 23: An apparatus comprising means for performing a method in accordance with of any of Clauses 1 through 21.

Clause 24: A non-transitory computer-readable medium having instructions stored thereon which, when executed by a processor, performs a method in accordance with of any of Clauses 1 through 21.

Clause 25: A computer program product embodied on a computer-readable storage medium comprising code for performing a method in accordance with of any of Clauses 1 through 21.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
partitioning a machine learning model into a plurality of partitions;
transmitting, to each respective participating device of a plurality of participating devices in a federated learning scheme, a request to update a respective partition of the plurality of partitions in the machine learning model based on unique data at the respective participating device;
receiving, from the plurality of participating devices, updates to one or more partitions in the machine learning model; and
updating the machine learning model based on the received updates.

2. The method of claim 1, wherein partitioning the machine learning model into the plurality of partitions comprises partitioning the machine learning model into a common subnetwork and one or more non-common subnetworks.

3. The method of claim 1, wherein partitioning the machine learning model into the plurality of partitions comprises orthogonalizing the partitions.

4. The method of claim 3, wherein orthogonalizing the partitions comprises generating the plurality of partitions based on Gram-Schmidt orthogonalization.

5. The method of claim 3, wherein orthogonalizing the partitions comprises generating the plurality of partitions based on singular value decomposition.

6. The method of claim 3, wherein orthogonalizing the partitions comprises generating the plurality of partitions based on Cholesky decomposition.

7. The method of claim 1, wherein partitioning the machine learning model comprises generating the plurality of partitions in the machine learning model based on a feature projection technique.

8. The method of claim 7, wherein:
each partition of the plurality of partitions is associated with a set of weights;
a first partition of the plurality of partitions comprises a common partition having a common set of weights; and
a plurality of second partitions of the plurality of partitions comprise partitions having weights associated with one of a plurality of defined scenarios for which the machine learning model is trained.

9. The method of claim 1, wherein partitioning the machine learning model comprises generating the plurality of partitions in the machine learning model based on a gradient projection technique.

10. The method of claim 9, wherein:
the plurality of partitions comprises a null space and a non-null space, and
the requests to update the one or more partitions in the plurality of partitions comprises requests to update subspaces in the non-null space.

11. The method of claim 1, further comprising:
receiving reports from each participating device of the plurality of participating devices; and
configuring, for each respective participating device of the plurality of participating devices, constraints for updating a partition in the machine learning model based on the received reports for the respective participating device.

12. The method of claim 11, wherein:
the one or more participating devices comprise one or more user equipments (UEs) in a wireless communication system,
the machine learning model comprises a model for predicting parameters for wireless communications between a network entity and a user equipment (UE), and
the data at each respective device comprises one or more radio measurements at each respective device.

13. The method of claim 1, wherein updating the machine learning model based on the received updates comprises aggregating weight updates from each participating device of the plurality of participating devices.

14. The method of claim 1, wherein the method is performed by a network entity in a wireless communication system, and wherein the plurality of participating devices comprises user equipments (UEs) served by the network entity.

15. A computer-implemented method, comprising:
receiving, from a server, information defining an orthogonal partition in a machine learning model to be updated and constraints for updating the orthogonal partition, wherein the orthogonal partition comprises a partition for a first participating device in a federated learning scheme that is decorrelated from a partition for a second participating device in the federated learning scheme;
updating the orthogonal partition in the machine learning model based on local data; and
transmitting, to the server, information defining the updated orthogonal partition in the machine learning model.

16. The method of claim 15, further comprising transmitting, to the server, one or more reports, wherein the constraints for updating the orthogonal partition are based on the one or more reports.

17. The method of claim 16, wherein the one or more reports include generalized information about the local data.

18. The method of claim 16, wherein the one or more reports comprise radio measurements corresponding to a general classification of radio conditions at a device.

19. The method of claim 15, wherein updating the orthogonal partition in the machine learning model comprises updating the orthogonal partition based on a feature projection technique and the local data.

20. The method of claim 15, wherein updating the orthogonal partition in the machine learning model comprises updating the orthogonal partition based on a gradient projection technique and the local data.

21. The method of claim 15, wherein the method is performed by a user equipment (UE) in a wireless communication system, and the server is associated with a network entity serving the UE in the wireless communication system.

22. A processing system, comprising:
a memory comprising computer-executable instructions stored thereon; and
one or more processors configured to execute the computer-executable instructions to cause the processing system to:
partition a machine learning model into a plurality of partitions;
transmit, to each respective participating device of a plurality of participating devices in a federated learning scheme, a request to update a respective partition of the plurality of partitions in the machine learning model based on unique data at the respective participating device;
receive, from the plurality of participating devices, updates to one or more partitions in the machine learning model; and
update the machine learning model based on the received updates.

23. The processing system of claim 22, wherein in order to partition the machine learning model into the plurality of partitions, the one or more processors are configured to:
partition the machine learning model into a common subnetwork and one or more non-common subnetworks, or
orthogonalize the partitions.

24. The processing system of claim 23, wherein in order to orthogonalize the partitions, the one or more processors are configured to generate the plurality of partitions based on one or more of Gram-Schmidt orthogonalization, singular value decomposition, or Cholesky decomposition.

25. The processing system of claim 22, wherein in order to partition the machine learning model, the one or more processors are further configured to generate the plurality of partitions in the machine learning model based on a feature projection technique,
each partition of the plurality of partitions is associated with a set of weights,
a first partition of the plurality of partitions comprises a common partition having a common set of weights, and
a plurality of second partitions of the plurality of partitions comprise partitions having weights associated with one of a plurality of defined scenarios for which the machine learning model is trained.

26. The processing system of claim 22, wherein:
in order to partition the machine learning model, the one or more processors are further configured to generate the plurality of partitions in the machine learning model based on a gradient projection technique,
the plurality of partitions comprises a null space and a non-null space, and
the requests to update the one or more partitions in the plurality of partitions comprises requests to update subspaces in the non-null space.

27. The processing system of claim 22, wherein the one or more processors are configured to:
receive reports from each participating device of the plurality of participating devices; and
configure, for each respective participating device of the plurality of participating devices, constraints for updating a partition in the machine learning model based on the received reports for the respective participating device.

28. The processing system of claim 27, wherein:
the plurality of participating devices comprises one or more user equipments (UEs) in a wireless communication system,
the machine learning model comprises a model for predicting parameters for wireless communications between a network entity and a user equipment (UE), and
the data at each respective device comprises one or more radio measurements at each respective device.

29. The processing system of claim 22, wherein in order to update the machine learning model, the one or more processors are configured to aggregate weight updates from each participating device of the plurality of participating devices.

30. A processing system, comprising:
a memory having computer-executable instructions stored thereon; and
one or more processors configured to execute the computer-executable instructions to:
receive, from a server, information defining an orthogonal partition in a machine learning model to be updated and constraints for updating the orthogonal partition, wherein the orthogonal partition comprises a partition for a first participating device in a federated learning scheme that is decorrelated from a partition for a second participating device in the federated learning scheme;
update the orthogonal partition in the machine learning model based on local data; and
transmit, to the server, information defining the updated orthogonal partition in the machine learning model.
